(19) United States
(12) Patent Application Publication
(10) Pub. No.: US 2010/0229065 A1
(43) Pub. Date: Sep. 9, 2010

(54) RADIO RECEPTION DEVICE, RADIO TRANSMISSION DEVICE, AND RADIO COMMUNICATION METHOD

(76) Inventors: Yasuaki Yuda, Kanagawa (JP); Masayuki Hoshino, Kanagawa (JP); Katsuhiko Hiramatsu, Kanagawa (JP)

Correspondence Address: Dickinson Wright PLLC;James E. Ledbetter, Esq., International Square, 1875 Eye Street, N.W., Suite 1200, Washington, DC, 20006, US

(21) Appl. No.: 12/739,123

(22) PCT Filed: Oct. 24, 2008
(86) PCT No.: PCT/JP2008/003028

§ 371 Date: Apr. 21, 2010

(30) Foreign Application Priority Data
Oct. 25, 2007 (JP) 2007-277911

(51) Int. Cl. H04L 1/14; G06F 11/16

(52) U.S. Cl. 714/750; 714/E11.058

(57) ABSTRACT

It is possible to provide a radio transmission device, a radio reception device, and a radio communication method which can suppress increase of the feedback overhead and improve the throughput characteristic. In ST 304, an UE performs an error judgment for each of CW. In ST 305, a comparison is made on quality between streams in the CW containing the error. ST 306 transmits Nack and quality difference information to a BS. In ST 307, it is reported to the BS that an error has occurred in the CW in the preceding transmission and that one of the streams is a high-quality stream. Moreover, ST 307 selects data which has been transmitted as CW retransmission data in a low-quality stream in the preceding transmission and decides to transmit the selected data from two streams. ST 308 generates a retransmission CW. ST 309 arranges the retransmission CW in the two streams and transmits the retransmission CW to the UE. ST 310 reproduces the CW which has been retransmitted from the BS and performs a symbol synthesis or a bit synthesis so as to reproduce the data which has been transmitted in a low-quality stream in the preceding transmission.

### TECHNICAL FIELD

The present invention relates to a radio receiving apparatus, radio transmitting apparatus and radio communication method for performing MIMO (Multiple Input Multiple Output) communication using a plurality of streams per codeword.

### BACKGROUND ART

In 3GPP (3rd Generation Partnership Project), which is international standards organization about mobile communication, studies are underway for a packet transmission system using HARQ (Hybrid Automatic Retransmission reQuest) combining coding and retransmission techniques, as a communication system for realizing fast data transmission.

In HARQ, an ACK/NACK indicating whether or not transmission packets have been transmitted without error, is fed hack from the receiving side to the transmitting side. If a NACK indicating the occurrence of error is detected in the transmitting side, data is retransmitted from the transmitting side. In this case, the retransmission data may be the same data as in the initial transmission or may be data that is encoded redundant bits of transmission data and that was not transmitted upon the initial transmission. The details of such retransmission data is reported using redundancy version, for example.

Also, as a scheme to realize even faster transmission of data of a larger capacity, an SDM (Space Division Multiplexing) transmission scheme, which is one of MIMO transmission schemes, is attracting attentions. MIMO transmission refers to a technique of transmitting signals using a plurality of antennas for performing transmission and reception, and SDM transmission refers to a technique of spatially multiplexing different signals (streams) using a plurality of antennas. By adopting this SDM transmission, it is possible to increase the efficiency of use of frequency without increasing time and frequency resources.

In SDM transmission, by adopting AMC (Adaptive Modulation and Coding) that adaptively controls HARQ and MCS (Modulation and Coding Scheme) per stream, it is possible to further improve the efficiency of use of frequency.

In AMC, the receiving side feeds back a CQI (Channel Quality Indicator) indicating received quality to the transmitting side, and the transmitting side selects the MCS matching the feedback CQI.

The control unit for these HARQ and MCS is referred to as “codeword,” and the transmitting method of controlling a plurality of codewords per stream is referred to as “MCW (Multiple CodeWord).”

As described above, with MCW that performs HARQ and AMC on a per stream basis, HARQ control information and AMC control information need to be reported or fed back on a per stream basis. Here, an ACK/NACK indicating an error detection result and redundancy version indicating the details of retransmission data are possible as HARQ control information, and the CQI and MCS are possible as AMC control information.

With this MCW, if the number of transmission streams increases, the amount of control information for these streams also increases, and, as a result, the link overhead increases and the efficiency of use of frequency decreases. Therefore, in order to suppress the overhead by control information, MCW is studied that reduces the number of codewords for controlling HARQ and AMC and that uses a plurality of streams per codeword. For example, MCW using two streams per codeword is possible as the method of using two codewords upon transmitting four streams, and this method is adopted in the standardization of the 3GPP LTE (Long Term Evolution) system (see Non-Patent Document 1).

Here, CW represents the coding bit sequence, and a stream represents the signal sequence that is transmitted by an antenna or beam. Non-Patent Document 1: 3GPP TS 36.211 ver. 2.0.0 “Physical Channels and Modulation”

### DISCLOSURE OF INVENTION

### Problems to be Solved by the Invention

The following two schemes are possible as a HARQ scheme in MCW using a plurality of streams. First, the first scheme (scheme 1) will be explained using FIG. 1. FIG. 1 shows a scheme in which a base station (hereinafter “BS”) and mobile terminal (hereinafter “UE”) each have four antennas, the BS transmits two CW's from the four antennas (streams) to the UE, and the UE feeds back CQI per antenna (stream) and ACK/NACK per CW to the BS. The BS calculates the CQI per CW from the CQI per antenna and generates CW's. Further, based on the CQI of each stream fed back from the UE, the BS arranges the generated CW's in streams and transmits the results. Upon the initial transmission, a new CW is transmitted adopting transmission power control and transmission CW stream arrangement control based on the CQI of each stream. Further, upon retransmitting a CW matching a NACK fed back from the UE, in the same way as in the initial transmission, the retransmission CW is transmitted by adaptive control based on the CQI of each stream.

Thus, a feature of this scheme lies in enabling adaptive control such as transmission power control and transmission CW stream arrangement control based on the quality of each stream both upon the initial transmission and upon retransmission, thereby providing high throughput performance. However, the CQI of each stream needs to be fed back, and therefore there is a problem of the increase of feedback overhead.

Next, the second scheme (scheme 2) will be explained using FIG. 2. FIG. 2 shows a scheme in which a UE feeds back a CQI and ACK/NACK to a BS on a per CW basis. The BS generates CW's based on the feedback CQI of each CW. Further, the BS arranges the generated CW's to predetermined streams and transmits them. This stream arrangement is applied both upon the initial transmission and upon retransmission.

Thus, a feature of this scheme lies in requiring only the CQI feedback for each CW and therefore providing small feedback overhead. However, both upon the initial transmission and retransmission, it is not possible to perform adaptive control between streams in a CW, and therefore there is a problem that the throughput performance is less than that of scheme 1.

It is therefore an object of the present invention to provide a radio receiving apparatus, radio transmitting apparatus and radio communication method for suppressing the increase of feedback overhead and improving throughput performance.

### Means for Solving the Problem

The radio receiving apparatus of the present invention employs a configuration having: stream connecting means for receiving a signal subjected to multiple input multiple output transmission using a plurality of streams per codeword, and regenerating a codeword by connecting streams from the received signal; error detecting means for performing an error detection of the regenerated codeword; quality difference information generating means for generating, when an error occurs in the codeword, quality difference information indicating a quality difference between streams in the codeword with the error; and feedback information transmitting means for transmitting the quality difference information and a response signal indicating the error in the codeword, as feedback information.

The radio transmitting apparatus of the present invention employs a configuration having: feedback information receiving means for receiving feedback information including quality difference information and a response signal indicating an error in a codeword, in response to a signal subjected to multiple input multiple output transmission using a plurality of streams per codeword; determining means for determining retransmission data and a stream which is a retransmission stream to arrange the retransmission data in, based on the received feedback information; and transmitting means for performing multiple input multiple output transmission of the determined retransmission data using the determined retransmission stream.

The radio communication method of the present invention includes: a stream connecting step of receiving, in a radio receiving apparatus, a signal subjected to multiple input multiple output transmission in a radio transmitting apparatus using a plurality of streams per codeword, and regenerating a codeword by connecting streams from the received signal; an error detecting step of performing an error detection of the regenerated codeword; a quality difference information generating step of generating, when an error occurs in the codeword, quality difference information indicating a quality difference between streams in the codeword with the error; a feedback information transmitting step of transmitting the quality difference information and a response signal indicating the error in the codeword, as feedback information, to the radio transmitting apparatus; a feedback information receiving step of receiving the feedback information in the radio transmitting apparatus; a determining step of determining retransmission data and a retransmission stream to arrange the retransmission data in, based on the received feedback information; and a transmitting step of performing multiple input multiple output transmission of the determined retransmission data to the radio receiving apparatus, using the determined retransmission stream.

### ADVANTAGEOUS EFFECT OF THE INVENTION

According to the present invention, it is possible to suppress the increase of feedback overhead and improve throughput performance.

### BRIEF DESCRIPTION OF DRAWINGS

FIG. 1 is a conceptual diagram showing a scheme adopting the HARQ scheme in MCW;

FIG. 2 is a conceptual diagram showing another scheme adopting the HARQ scheme in MCW;

FIG. 3 is a block diagram showing the configuration of a BS according to an embodiment of the present invention;

FIG. 4 is a block diagram showing the configuration of a UE according to an embodiment of the present invention;

FIG. 5 shows the magnitude of bit likelihood in a CW in which an error has occurred;

FIG. 6 illustrates a table showing the relationships of bit likelihoods and quality difference between streams;

FIG. 7 shows a field in which information about quality differences between streams is stored in uplink control information;

FIG. 8 illustrates a table showing information about quality differences between streams by two bits; and

FIG. 9 is a sequence diagram showing the communication steps between a BS and a UE.

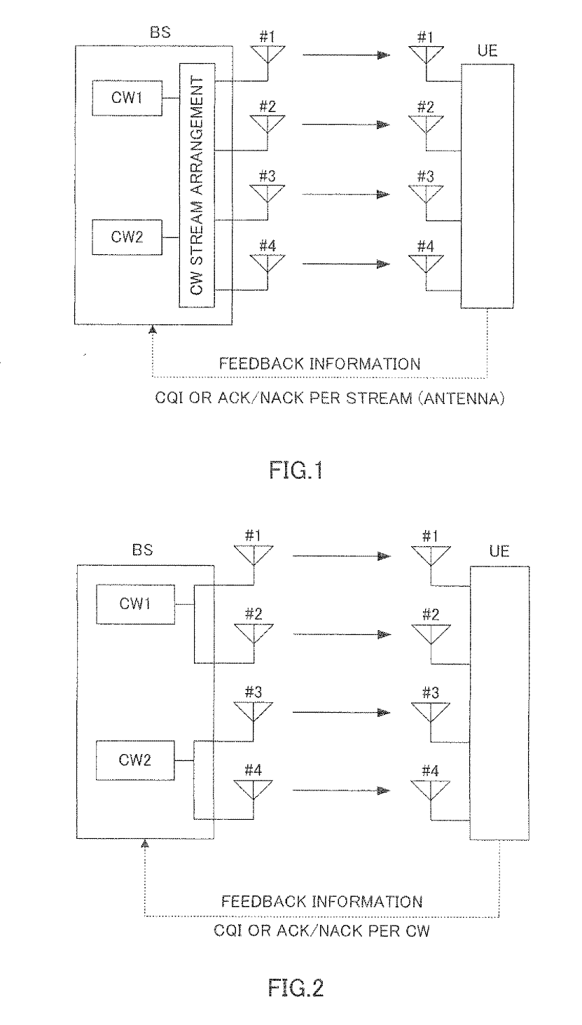

### BEST MODE FOR CARRYING OUT THE INVENTION

In a MIMO transmission scheme for transmitting a plurality of streams per CW, the quality difference between streams in a CW is one of cause of errors that occur in the CW. A CW is the control unit in AMC, and therefore one MCS is selected in a CW to use the same coding rate and modulation scheme. If such CW's are arranged in a plurality of streams and produce quality differences between these streams, the good quality part and the poor quality part are provided in one CW. In the good quality part, sufficient error performance is secured in the case of transmission with the MCS selected in the CW. On the other hand, in the poor quality part, error performance is bad even in the case of transmission with the MCS selected in the CW, which may cause errors.

Thus, the present inventors focus on the fact that errors may occur in a CW due to the influence of poor quality parts in the ease where there are quality differences in the CW, and that information about quality differences between streams is not always required only in the case where errors occur in the CW.

An embodiment of the present invention will be explained below in detail with reference to the accompanying drawings.

### Embodiment

The present embodiment presumes a system where the number of transmission CW's is two and two streams are transmitted per CW. Also, assume that the transmission method upon the initial transmission is the same as scheme 2 shown in FIG. 2.

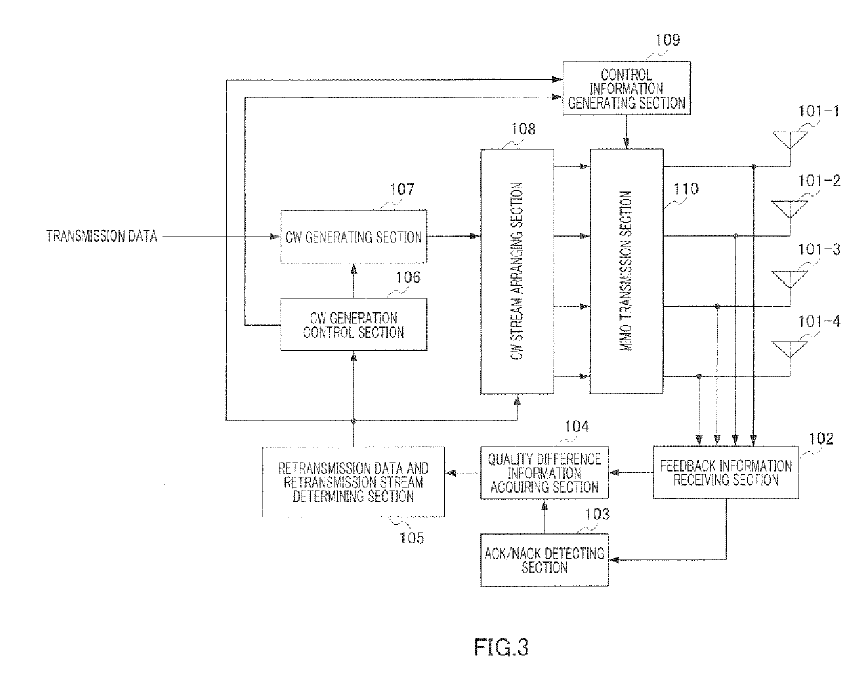

FIG. 3 is a block diagram showing the configuration of a BS according to an embodiment of the present invention. In this figure, feedback information receiving section 102 receives feedback information transmitted from a UE, which will be described later, via four antennas 101-1 to 101-4, and performs receiving processing of this feedback information. The feedback information subjected to receiving processing is outputted to ACK/NACK detecting section 103 and quality difference information acquiring section 104.

ACK/NACK detecting section 103 detects ACK/NACK information included in the feedback information outputted from feedback information receiving section 102, and outputs the detected ACK/NACK information to quality difference information acquiring section 104.

If a NACK is outputted from ACK/NACK detecting section 103, quality difference information acquiring section 104 acquires inter-stream quality difference information included in the feedback information outputted from feedback information receiving section 102, and outputs the inter-stream quality difference information to retransmission data and retransmission stream determining section 105. Further, if an ACK is outputted from ACK/NACK detecting section 103, quality difference information acquiring section 104 sends a notice of that effect to retransmission data and retransmission stream determining section 105.

If inter-stream quality difference information is outputted from quality difference acquiring section 104, retransmission data and retransmission stream determining section 105 determines retransmission data and streams to arrange the retransmission data in (i.e. retransmission streams), based on the inter-stream quality difference information. The determined retransmission data and retransmission streams are outputted to CW generation control section 106, CW stream arranging section 108 and control information generating section 109 as retransmission stream arrangement information. By contrast, if an ACK is reported from quality difference information acquiring section 104, generation of a new CW is commanded to CW generation control section 106, CW stream arranging section 108 and control information generating section 109. Also, the streams to arrange the new CW in, are determined in advance.

CW generation control section 106 sets, for example, the data length of the retransmission CW based on the retransmission stream arrangement information outputted from retransmission data and retransmission stream determining section 105. Also, upon transmitting a new CW, CW generation control section 106 sets the MCS for the new CW based on CQI information (not shown). The set CW control details are outputted to CW generating section 107 and control information generating section 109. Also, the CW control details include information for identifying whether the CW is a new CW or a retransmission CW. Further, in the case where there is a retransmission CW, the control details includes information for specifying what data is retransmitted. These items of information are referred to as “information relating to retransmission.”

CW generating section 107 generates a CW based on the CW control details outputted from CW generation control section 106. In this case, a new CW is generated by attaching error detection codes such as CRC codes to new transmission data and performing error correction coding such as turbo coding. Also, in ease where CW has an error and a retransmission occurs, encoded data is stored. On the other hand, a retransmission CW is generated by extraction from the stored encoded data based on the CW control details (such as the data length) outputted from CW generation control section 106. The generated CW is outputted to CW stream arranging section 108.

CW stream arranging section 108 arranges a CW outputted from CW generating section 107 in streams. To be more specific, a new CW is arranged in predetermined streams. Also, a retransmission CW is arranged in streams based on the retransmission stream arrangement information outputted from retransmission data and retransmission stream determining section 105. The CW arranged in the streams is outputted to MIMO transmission section 110.

Control information generating section 109 generates control information based on the CW control details outputted from CW generation control section 106 and the retransmission stream arrangement information outputted from retransmission data and retransmission stream determining section 105, and outputs the control information to MIMO transmission section 110.

MIMO transmission section 110 performs SDM transmission of a plurality of streams of the CW outputted from CW stream arranging section 108. For example, MIMO transmission section 110 transmits the streams from different antennas 101-1 to 101-4, or multiplies these streams by a transmission weight and transmits the results from antennas 101-1 to 101-4. Also, MIMO transmission section 110 transmits the control information outputted from control information generating section 109. Here, it is not always necessary to use SDM to transmit control information.

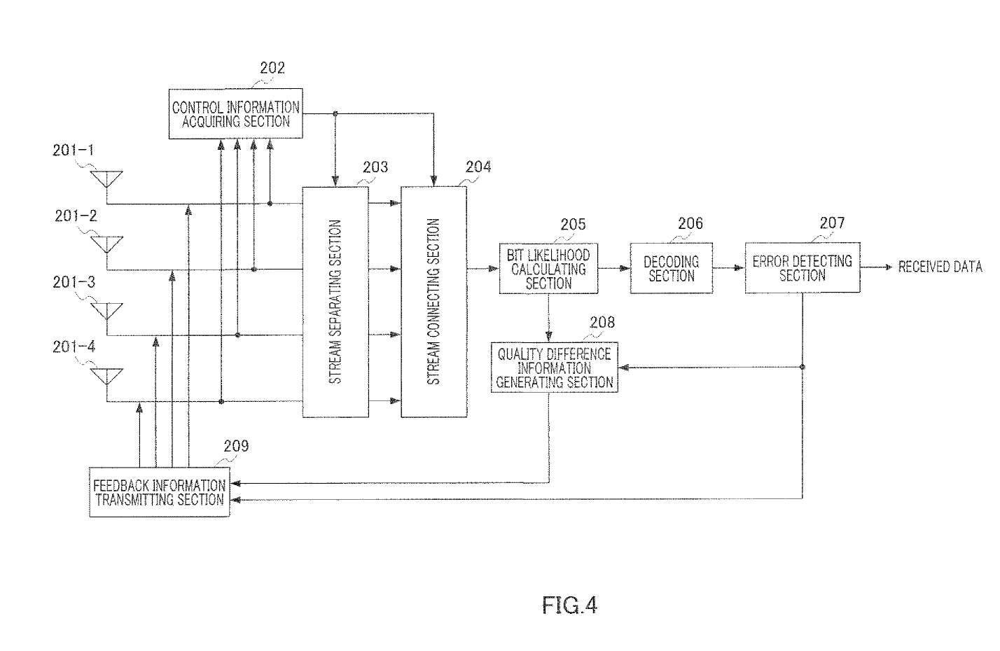

FIG. 4 is a block diagram showing the configuration of a UE according to an embodiment of the present invention. In this figure, control information acquiring section 202 acquires control information transmitted form the BS shown in FIG. 3, via four antennas 201-1 to 201-4. The control information includes MCS information of each CW and information relating to retransmission. Also, in the case where there is a retransmission CW, the control information includes retransmission stream arrangement information. The acquired retransmission stream arrangement information is outputted to stream separating section 203 and stream connecting section 204. Also, MCS information of each CW and information relating to retransmission are generally used for, for example, separating and decoding streams (this is not shown in FIG. 4).

Stream separating section 203 receives signals subjected to SDM transmission from the BS shown in FIG. 3, via four antennas 201-1 to 201-4, and performs stream separating processing of the received signals. For example, the stream separating method by filtering such as zero forcing and MMSE, and the stream separating method by SIC are applicable. Also, in the case where there is a retransmission CW, stream separating processing is performed using the retransmission stream arrangement information outputted from control information acquiring section 202. These separated streams are outputted to stream connecting section 204.

Stream connecting section 204 regenerates a CW by connecting streams outputted from stream separating section 203. If there is a retransmission CW, a retransmission CW is regenerated using the retransmission stream arrangement information outputted from control information acquiring section 202. The regenerated CW is outputted to bit likelihood calculating section 205.

Bit likelihood calculating section 205 calculates the bit likelihood of a CW outputted from stream connecting section 204. Here, if a CW outputted form stream connecting section 204 is a retransmission CW, the bit likelihood previously calculated and the bit likelihood currently calculated are combined. Further, bit likelihood calculating section 205 stores the calculated bit likelihood and outputs it to decoding section 206 and quality difference information generating section 208.

Decoding section 206 performs decoding processing of CW's using the bit likelihoods of the CW's outputted from bit likelihood calculating section 205, and outputs the decoding results to error detecting section 207. Error detecting section 207 performs CRC detection of the CW decoding result outputted from decoding section 206 and decides whether or not there are errors. If it is decided that there are no errors, the CW decoding result is outputted as received data. Further, the detection result is outputted to quality information generating section 208 and feedback information transmitting section 209 as ACK/NACK information.

If ACK/NACK information outputted from error detecting section 207 indicates a NACK, quality information generating section 208 acquires the bit likelihoods with respect to the CW in which a NACK is detected, from bit likelihood calculating section 205, and decides the quality differences between streams. Quality difference information generating section 208 generates information about quality differences between streams from the decision result and outputs the quality difference information to feedback information transmitting section 209.

Feedback information transmitting section 209 feeds back ACK/ANCK information outputted from error detecting section 207 and, if quality difference information is outputted from quality difference information generating section 208, feeds back the quality difference information, to the BS shown in FIG. 3.

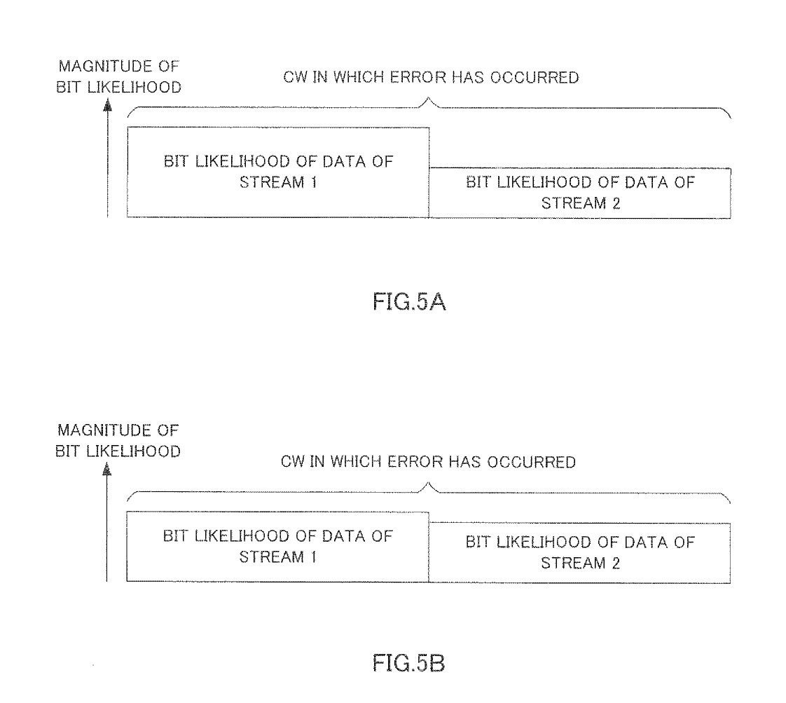

Now, FIG. 5 shows the magnitude of bit likelihoods in a CW in which an error has occurred. FIG. 5A shows a state where there is a significant quality difference between streams in a CW in which an error has occurred. Also, FIG. 5B shows a state where there is a small quality difference between streams.

In the CW connecting stream 1 and stream 2 in FIG. 5A, there is significant quality difference between streams, and the data transmitted by stream 2 of lower quality than the data transmitted by stream 1 of high quality is considered as the cause of error. Therefore, by reliably retransmitting data transmitted by this stream 2, it is possible to solve the error. On the other hand, as shown in FIG. 5B, even if an error occurs in a CW, the quality difference between streams may be small. In this case, the quality difference between the streams is unlikely considered as the cause of errors.

Thus, based on the quality difference between streams in an error CW, it is possible to identify the stream of the cause of errors.

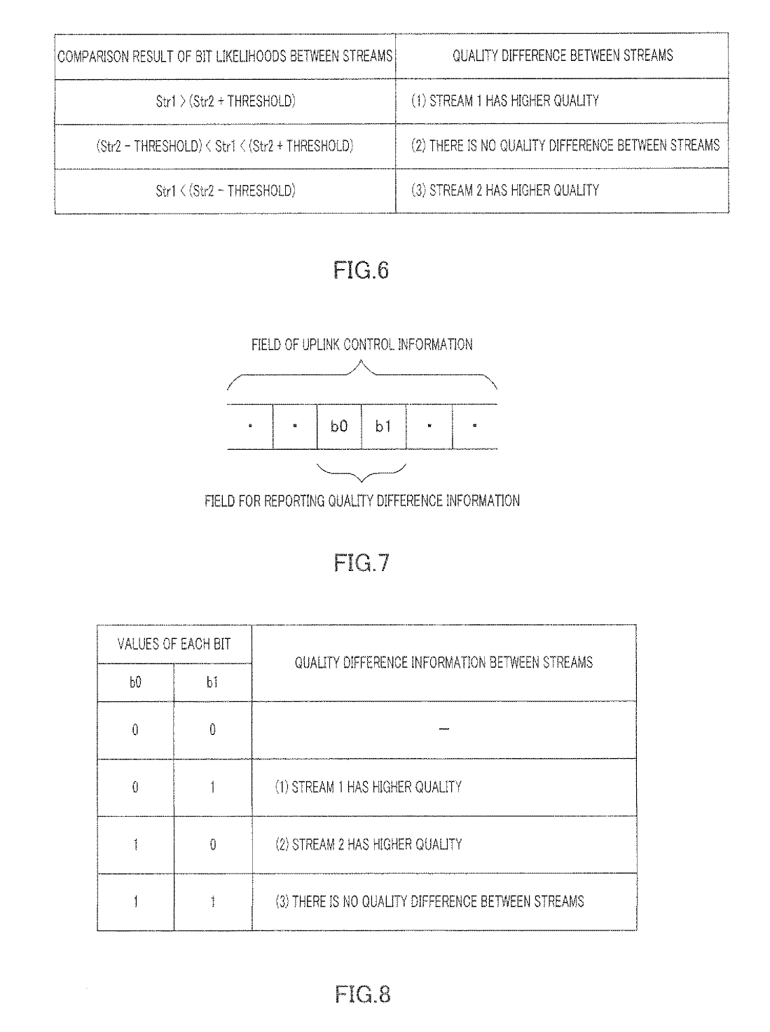

Next, a method of generating information about quality differences between streams in a UE will be explained. Bit likelihood calculating section 205 calculates an average bit likelihood value per stream. Further, using the table shown in FIG. 6 showing the relationships of bit likelihoods and quality differences between streams, information about quality differences between streams is selected based on a comparison result of the bit likelihood average values between streams. In FIG. 6, “Str1” is the bit likelihood average value of stream 1, and “Str2” is the bit likelihood average value of stream 2. Also, as for a threshold, a value at which the difference of magnitude of bit likelihoods between streams is the cause of error, is calculated and set in advance. This value varies according to, for example, the data length of a CW, and therefore assigns various values depending on what system is assumed. For example, in the case of FIG. 5A, information (1) “stream 1 has higher quality” in FIG. 6 is selected as information about quality differences between streams, and, in the case of FIG. 5B, information (2) “there is no quality difference between streams” in FIG. 6 is selected as information about quality differences between streams. The UE feeds back the information about quality differences between streams determined as above to the BS together with a NACK.

Next, a method of feeding back information about quality differences between streams to a BS will be explained. To be more specific, a method of reporting quality difference information from a UE to a BS by uplink control information, will be explained. Examples of this uplink control information include a PUCCH (Physical Uplink Control CHannel) in the above LTE system. First, as shown in FIG. 7, a two-bit field (b0, b1) is secured in uplink control information. Further, as shown in FIG. 8, information about quality differences between streams is defined with respect to these two bits (b0, b1), and the UE and the BS share in advance the association relationships shown in this FIG. 8. By this means, the UE can feed back information about quality differences between streams to the BS using the field for two bits secured in uplink control information.

Also, in FIG. 7, although a field for reporting quality difference information is secured in uplink control information, only in the case where a NACK occurs, a field for reporting other information can be used instead of that field for reporting quality difference information. For example, only in the case where a NACK occurs, for example, there is a method of using a field for reporting the CQI of an error CW instead of a field for reporting quality difference information.

Also, in FIG. 8, although information is not reported in the case of (b0, b1)=(0, 0), it is equally possible to report other information in this case. For example, (b0, b1)=(0, 0) may be used to report that both streams have high quality and therefore no quality difference, and (b0, b1)=(1, 1) may be used to report that both streams have low quality and therefore no quality difference.

Also, although FIG. 6 and FIG. 8 set three levels of quality differences between streams, it is equally possible to set more levels of quality differences. In this case, it is possible to express quality differences between streams stepwise. Also, it is equally possible to set quality differences between streams in one level. In this case, one of information (1) “stream 1 has higher quality” and information (3) “stream 2 has higher quality” is reported, and information (2) “there is no quality difference between streams” is not reported. This is because each stream in a CW passes an independent channel, not a few quality differences occur between streams, and therefore it is possible to omit information (2) “there is no quality difference between streams.”

Next, a retransmission method in a BS will be explained. A BS arranges retransmission data in streams based on information about quality differences between streams and transmits the result. In this case, the following methods are possible.

(a) Retransmission Method that Prioritizes Data Transmitted by the Lower-Quality Stream

In HARQ, retransmission data and the initial transmission data are combined, so that it is not necessary upon retransmission to retransmit data transmitted by the higher-quality stream upon the initial transmission. Therefore, by reliably transmitting data transmitted by the lower-quality stream upon the initial transmission, it is possible to eliminate errors with data combining the initial transmission data and retransmission data after retransmission. Therefore, upon retransmission, data transmitted by the lower-quality stream is preferentially retransmitted. Data transmitted by the lower-quality stream will be referred to as “low-quality data.”

(a-1) Retransmit Low-Quality Data from Two Streams

The error robustness of low-quality data is enhanced by, for example, performing repetition, adding redundant bits and reducing the M-ary value for the low-quality data, and the low-quality data is retransmitted from two streams. By enhancing the error robustness, an increased amount of transmission data compared to the initial transmission is retransmitted with two streams. By this means, retransmission data has higher error robustness and can be transmitted reliably.

(a-2) Retransmit Low-Quality Data with the Higher-Quality Stream and Stop Transmission with the Lower-Quality Stream

Low-quality data is retransmitted from the higher-quality stream. Further, data is not transmitted from the lower-quality stream. By this means, the number of transmission streams decreases, so that it is possible to distribute the power for antennas at which transmission is stopped, to other transmission antennas, and improve received power. Also, by improving reception diversity gain, it is possible to transmit retransmission data reliably.

(a-3) Retransmit Low-Quality Data with the Higher-Quality Stream and Additionally Transmit New Data from the Lower-Quality Stream

Low-quality data is retransmitted from the higher-quality stream, and new data is added and transmitted from the lower-quality stream. Thus, it is possible to transmit retransmission data reliably by retransmitting low-quality data from the higher-quality stream, and, furthermore, improve throughput by adding new data.

(a-4) Retransmit Low-Quality Data with the Higher-Quality Stream and Retransmit Redundant Bits from the Lower-Quality Stream

Low-quality data is retransmitted from the higher-quality stream, and redundant bits of the whole CW, which were not transmitted upon the initial transmission, are retransmitted from the lower-quality stream. By retransmitting low-quality data from the higher-quality stream, it is possible to transmit retransmission data reliably, and, furthermore, improve the error correction effect by adding redundant bits of the whole CW.

(b) A Retransmitting Method of Switching Transmission Streams

Data transmitted with the higher-quality stream is retransmitted with the lower-quality stream, and data retransmitted with the lower-quality stream is retransmitted with the higher-quality stream. By this means, data combining the retransmission data and the initial transmission data has average quality, so that it is possible to eliminate errors reliably.

(C) A Retransmitting Method of Arranging Data Based on Quality Between Streams

Based on quality between streams, transmission is performed by prioritizing the systematic bits of an error correction code in the higher-quality stream, and transmission is performed by prioritizing the parity bits of the error correction code in the lower-quality stream. By this means, it is possible to maintain the quality of systematic bits that are important for the error correcting performance upon decoding, so that it is possible to eliminate errors.

Also, with information about quality differences between streams from a UE, if it is decided that there is no quality difference between streams, retransmission based on the quality differences between streams is not applied, and retransmission data is arranged in predetermined streams and retransmitted as in above scheme 2.

Also, the above methods of generating retransmission data and arranging retransmission streams are determined in retransmission data and retransmission stream determining section 105 and reported from the BS to the UE by means of control information. Based on this report, the UE performs stream separating processing and combination processing of initial transmission data and retransmission data.

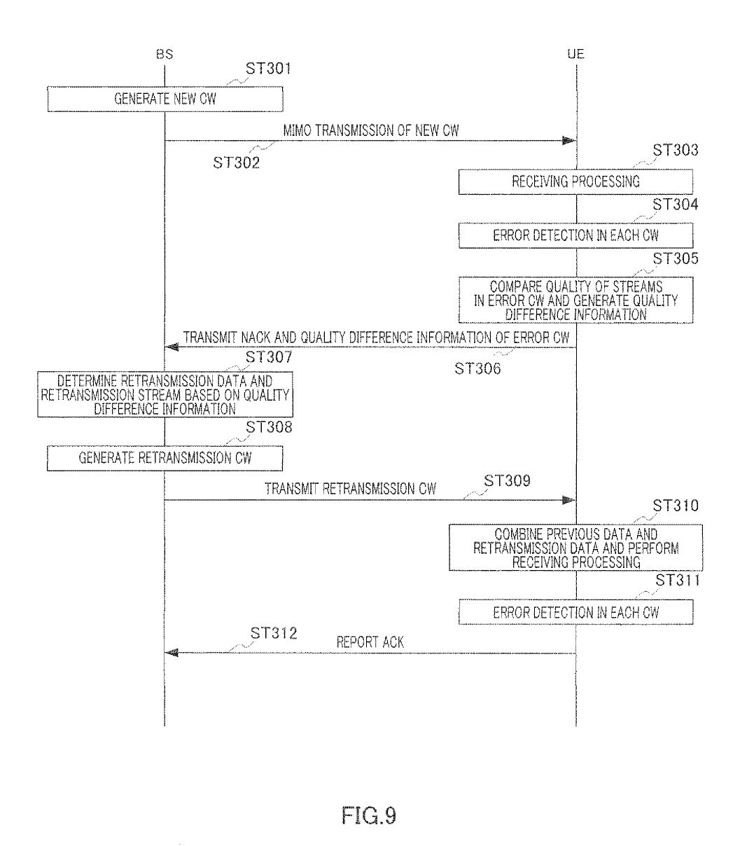

Next, the communication steps will be explained with FIG. 9, where the above retransmission method (a-1) is applied. In step (hereinafter abbreviated to “ST”) 301, CW generating section 107 of the BS generates a new CW, and, in ST 302, performs MIMO transmission of the new CW with predetermined streams from MIMO transmission section 110 to the UE.

In ST 303, the UE receives the CW transmitted from the BS, performs processing of separating streams, connecting streams and decoding on the received CW, and, in ST 304, error detecting section 207 performs an error decision on a per CW basis. Here, assume that an error is detected in CW 1.

In ST 305, quality difference information generating section 208 finds quality differences between streams, that is, compares bit likelihoods between streams in CW 1 with errors. Here, it is decided that the bit likelihood of stream 2 is higher than the bit likelihood of stream 1 and that stream 1 has the higher quality, and information about quality differences between streams is generated. In ST 306, a NACK and quality difference information are transmitted from feedback information transmitting section 209 to the BS.

In ST 307, it is reported to retransmission data and retransmission stream determining section 105 in the BS that an error has occurred in CW 1 in the previous transmission and stream 1 is the higher-quality stream. Retransmission data and retransmission stream determining section 105 then selects the data previously transmitted with stream 2 as retransmission data of CW 1, and determines to transmit the selected data from the two streams of stream 1 and stream 2.

In ST 308, CW generating section 107 generates retransmission CW 1 by doubling the data length of the data previously transmitted with stream 2, using repetition. In ST 309, CW stream arranging section 108 arranges retransmission CW 1 in both stream 1 and stream 2, and MIMO transmission section 110 transmits the results to the UE.

In ST 310, the CW retransmitted from the BS is regenerated in stream connecting section 204 and subjected to symbol combination or bit combination to regenerate the data previously transmitted with stream 2. Further, the CW data previously transmitted and the regenerated data are combined to calculate the bit likelihood of CW 1. Further, decoding section 206 performs decoding processing of the retransmission CW using the combined bit likelihood.

In ST 311, as in ST 304, error detecting section 207 performs an error detection on a per CW basis. Here, assume that no error is detected. In ST 312, feedback information transmitting section 209 transmits an ACK to the BS.

Thus, according to the present embodiment, if an error occurs in a CW in a system to transmit a plurality of streams per CW, a UE feeds back quality difference information indicating quality differences between streams in the error CW to a BS, and the BS determines retransmission data and retransmission streams based on the quality difference information and retransmits the CW, so that it is possible to suppress the increase of feedback overhead and correct the cause of errors.

Also, although a case has been described above with the present embodiment where the higher-quality stream is reported as information about quality differences between streams, the present invention is not limited to this, and it is equally possible to report the lower-quality stream.

Also, although a case has been described above with the present embodiment where the arrangement of streams is controlled in an error CW, it is equally possible to control the arrangement of streams between CW's. For example, when a plurality of consecutive errors occur in a plurality of CW's, the higher-quality stream and the lower-quality stream are found in each CW, and therefore the arrangement of CW streams can be reconfigured with a combination of those streams. In this case, information of reconfiguring the arrangement of CW streams is reported from the BS to the UE.

Also, although an example case has been described above with the present embodiment where the magnitude of bit likelihood is used as the quality of each received stream, the present invention is not limited to this, and it is equally possible to use the received SINR (Signal to Interference and Noise Ratio), received SNR (Signal to Noise Ratio), received power, and so on.

Also, although an example case has been described above with the present embodiment where a BS represents the transmitting apparatus and a UE represents the receiving apparatus, the present invention is not limited to this, and a BS may represent the receiving apparatus and a UE may represent the transmitting apparatus.

Although a case has been described above with the above embodiments as an example where the present invention is implemented with hardware, the present invention can be implemented with software.

Furthermore, each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-277911, filed on Oct. 25, 2007, including the specification, drawings and abstract, is incorporated herein by reference in its entirety.

### INDUSTRIAL APPLICABILITY

The radio receiving apparatus, radio transmitting apparatus and radio communication method can suppress the increase of feedback overhead and improve throughput performance, and are applicable to, for example, a radio communication base station apparatus and radio communication mobile station apparatus in a mobile communication system.

1-12. (canceled)

13. A radio receiving apparatus comprising:
a stream connecting section that receives a signal subjected to multiple input multiple output transmission using a plurality of streams per codeword, and regenerates a codeword by connecting the plurality of streams from the received signal;
an error detecting section that performs an error detection of the regenerated codeword;
a quality difference information generating section that generates, when an error occurs in the codeword, quality difference information indicating a quality difference between the plurality of streams in the regenerated codeword with the error; and
a feedback information transmitting section that transmits the quality difference information and a response signal indicating the error in the regenerated codeword, as feedback information.

14. A radio transmitting apparatus comprising:
a feedback information receiving section that receives feedback information including a response signal indicating an error of a codeword connected a plurality of streams and quality difference information indicating a quality difference between the plurality of streams in the codeword;
a determining section that determines retransmission data and a retransmission stream to arrange the retransmission data in, based on the received feedback information; and
a transmitting section that performs multiple input multiple output transmission of the determined retransmission data using the determined retransmission stream.

15. The radio transmitting apparatus according to claim 14, wherein the determining section determines preferentially retransmitting data transmitted using a stream of low quality in a codeword with an error.

16. The radio transmitting apparatus according to claim 15, wherein the determining section determines retransmitting, using a plurality of retransmission streams, data transmitted using the stream of low quality in the codeword with the error.

17. The radio transmitting apparatus according to claim 15, wherein the determining section determines retransmitting, using a retransmission stream of high quality, data transmitted using the stream of low quality in the codeword with the error.

18. The radio transmitting apparatus according to claim 17, wherein the determining section determines to stop the transmission of data using the retransmission stream of low quality.

19. The radio transmitting apparatus according to claim 17, wherein the determining section determines transmitting new data using the retransmission stream of low quality.

20. The radio transmitting apparatus according to claim 17, wherein the determining section determines transmitting a redundant bit that has not been transmitted using the retransmission stream of low quality.

21. The radio transmitting apparatus according to claim 14, wherein the determining section determines transmitting data transmitted using a stream of low quality in a codeword with an error, using a retransmission stream of high quality, and transmitting data transmitted using the stream of high quality in the codeword with an error, using the retransmission stream of low quality.

22. The radio transmitting apparatus according to claim 14, wherein, based on the received feedback information, the determining section determines transmission by prioritizing systematic bits of error correction coded retransmission data using a retransmission stream of high quality, and determines transmission by prioritizing parity bits of the error correction coded retransmission data in a retransmission stream of low quality.

23. A radio receiving method comprising:
receiving a signal subjected to multiple input multiple output transmission using a plurality of streams per codeword;
regenerating a codeword by connecting the plurality of streams from the received signal;
performing an error detection of the regenerated codeword;
when an error occurs in the codeword, generating quality difference information indicating a quality difference between the plurality of streams in the regenerated codeword with the error; and
transmitting the quality difference information and a response signal indicating the error in the regenerated codeword, as feedback information.

24. A radio transmitting method comprising:
receiving feedback information including a response signal indicating an error of a codeword connected a plurality of streams and quality difference information indicating a quality difference between the plurality of streams in the codeword and;
determining retransmission data and a retransmission stream to arrange the retransmission data in, based on the received feedback information; and
performing multiple input multiple output transmission of the determined retransmission data using the determined retransmission stream.
